(19) United States
(12) Patent Application Publication
(10) Pub. No.: US 2026/0318138 A1
(43) Pub. Date: Oct. 15, 2026

(54) LID DEVICE

(71) Applicant: ALPHA CORPORATION, Kanagawa (JP)

(72) Inventor: Mitsuo NISHIZUKA, Kanagawa (JP)

(73) Assignee: ALPHA CORPORATION, Kanagawa (JP)

(21) Appl. No.: 19/462,973

(22) Filed: Jan. 28, 2026

Related U.S. Application Data
(63) Continuation of application No. PCT/JP2024/023908, filed on Jul. 2, 2024.

(30) Foreign Application Priority Data
Jul. 28, 2023 (JP) 2023-123664

(51) Int. Cl. E05F 3/16; B60K 15/05; B60L 53/16

(52) U.S. Cl. CPC E05F 3/16; B60K 15/05; B60L 53/16; E05Y 2201/26; E05Y 2201/638; E05Y 2900/534

(57) ABSTRACT

A lid device that is attached to a fuel filler port or a power supply port of a vehicle and opens and closes the fuel filler port or the power supply port includes: a housing assembled to the fuel filler port or the power supply port of the vehicle; a shaft member pivotally supported by the housing; and a lid pivotably supported by the shaft member and displaceable between a closed position and an open position. The shaft member is provided with an extending piece extending in a direction intersecting an axial direction, and the housing is provided with a sliding contact portion with which the extending piece comes into sliding contact when the lid is displaced from the closed position to the open position.

### CROSS-REFERENCE TO RELATED APPLICATIONS

This is a continuation of International Application No. PCT/JP2024/023908 filed on Jul. 2, 2024, and claims priority from Japanese Patent Application No. 2023-123664 filed on Jul. 28, 2023, the entire content of which is incorporated herein by reference.

### TECHNICAL FIELD

The present disclosere relates to a lid device.

### BACKGROUND ART

In the related art, as a lid device for opening and closing a fuel filler port or a power supply port of a vehicle such as an automobile, there is a lid device that includes a housing mounted on the fuel filler port, and a lid opening and closing an opening of the housing, for example, see EP0887218A2.

This kind of lid device generally includes a biasing member such as a spring, and the biasing member biases the lid in an opening direction. When the fuel filler port or the power supply port is closed, the lid is locked to the housing, and when the operator releases the lock, the lid is opened by a biasing force of the biasing member. However, if the biasing force of the biasing member is strong, the lid may be opened forcefully, which may reduce the durability of the lid itself and a lid opening and closing mechanism. Therefore, in opening and closing structures in the related art, a method of making opening and closing operation (particularly, opening) of the lid gentle has been proposed.

In the devices in the related art, an oil damper is sometimes used to slow down the opening and closing operation (particularly, opening) of the lid. However, the oil damper is expensive and therefore undesirable from a cost perspective. On the other hand, in some devices among the devices in the related art, a structure for reducing momentum when the lid is opened without using the oil damper has been proposed, but all of these devices have a complicated structure and have room for improvement.

The present disclosure provides a lid device having a simple structure and capable of reducing momentum when a lid is opened.

### SUMMARY

According to an embodiment of the present disclosure, a lid device that is attached to a fuel filler port or a power supply port of a vehicle and opens and closes the fuel filler port or the power supply port includes: a housing assembled to the fuel filler port or the power supply port; a shaft member pivotally supported by the housing; and a lid pivotably supported by the shaft member and displaceable between a closed position and an open position. The shaft member is provided with an extending piece extending in a direction intersecting an axial direction, and the housing is provided with a sliding contact portion with which the extending piece comes into sliding contact when the lid is displaced from the closed position to the open position.

### Advantageous Effects of Invention

According to the present disclosure, the lid device having a simple structure and capable of reducing momentum when the lid is opened can be provided.

### BRIEF DESCRIPTION OF DRAWINGS

FIG. 1 is a perspective view of a rear fender of a vehicle on which a lid device is mounted;

FIGS. 2A and 2B are perspective views of the lid device according to the present embodiment, in which FIG. 2A illustrates a closed state of a lid, and FIG. 2B illustrates an open state of the lid;

FIG. 3 is an exploded perspective view of a main part of the lid device according to the present embodiment;

FIG. 4 is a perspective view of a housing in the lid device according to the present embodiment as viewed from a lower side and a rear side;

FIGS. 5A and 5B are views illustrating a support body in the lid device according to the present embodiment, in which FIG. 5A is a front view, and FIG. 5B is a top view;

FIG. 6 is a perspective view of a lid body in the lid device according to the present embodiment as viewed from a rear side;

FIGS. 7A and 7B are views illustrating a shaft member in the lid device according to the present embodiment, in which FIG. 7A is a perspective view viewed from an upper side, and FIG. 7B is a perspective view viewed from a lower side; and

FIGS. 8A and 8B are enlarged views of a portion A in FIG. 4, in which FIG. 8A illustrates an aspect when the lid is in the closed state, and FIG. 8B illustrates an aspect when the lid is in the open state (however, the lid is not illustrated).

### DESCRIPTION OF EMBODIMENTS

A specific embodiment of the present disclosure will be described below with reference to the drawings. For convenience of description, a state in which a lid 20 is at a closed position is referred to as a “closed state”, and a state in which the lid 20 is at an open position is referred to as an “open state”.

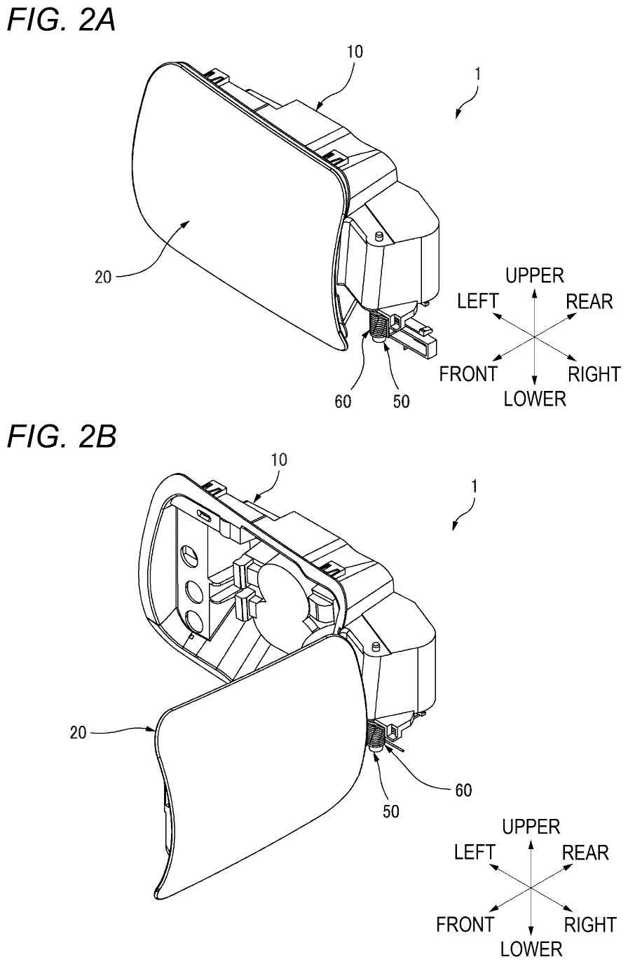

Hereinafter, for convenience of description, as illustrated in FIG. 2A to FIG. 8B, “front”, “rear”, “left”, “right”, “upper”, and “lower” are defined. A “front-rear direction”, a “left-right direction”, and an “upper-lower direction” are orthogonal to each other. The upper-lower direction corresponds to an “axial direction” of the present disclosure. The left-right direction is a feature that corresponds to an “intersecting direction” of the present disclosure. Each of the defined directions may or may not coincide with each of the directions at the time of attachment to a vehicle.

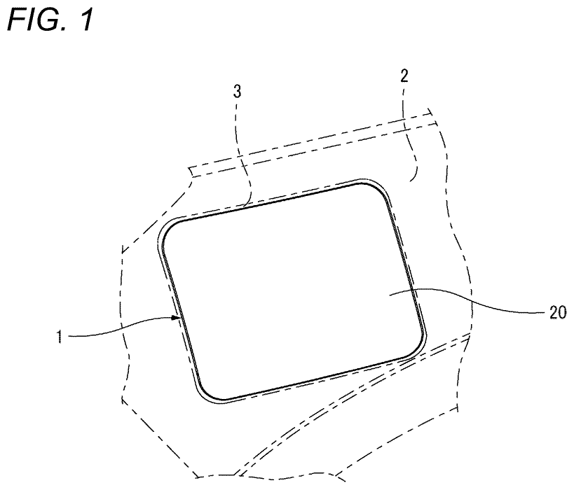

FIG. 1 is a perspective view of a rear fender 2 of the vehicle on which a lid device 1 is mounted.

As illustrated in FIG. 1, a lid device 1 according to the present embodiment is mounted on a fuel filler port or a power supply port (in this example, a fuel filler port 3) provided in a vehicle body such as the rear fender 2 of the vehicle such as an automobile. The lid device 1 includes the lid 20 that opens and closes the fuel filler port 3. A user performs an fuel filling operation on the vehicle in a state in which the fuel filler port 3 is open, and closes the fuel filler port 3 with the lid 20 of the lid device 1 after the fuel filling operation is completed. The lid device 1 has a lock mechanism that locks the lid 20 in a state in which the fuel filler port 3 is closed, and for example, the lid 20 can be opened and closed by releasing the lock in conjunction with an operation of an opener in a vehicle interior or an operation of unlocking a door lock of the vehicle.

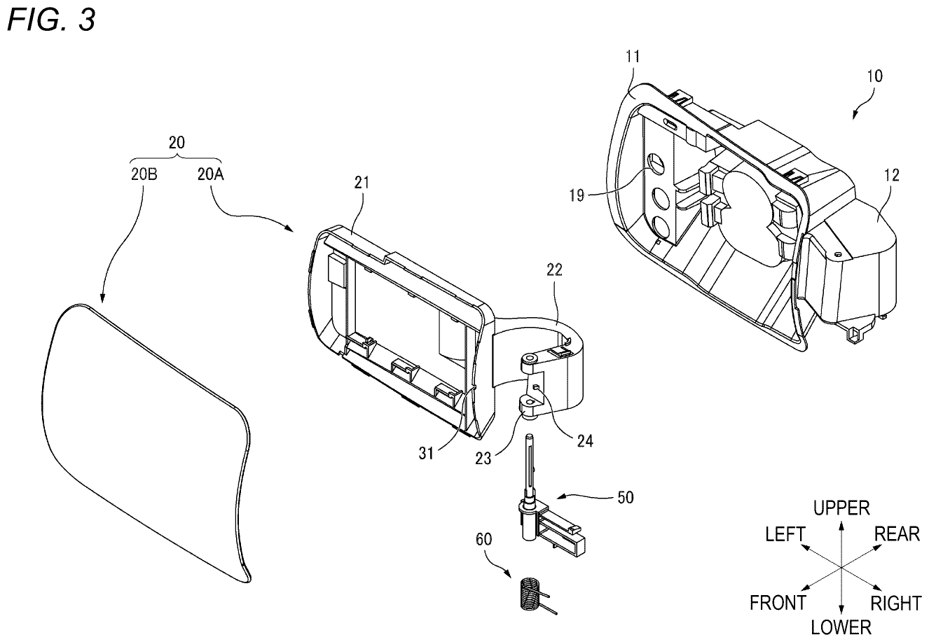

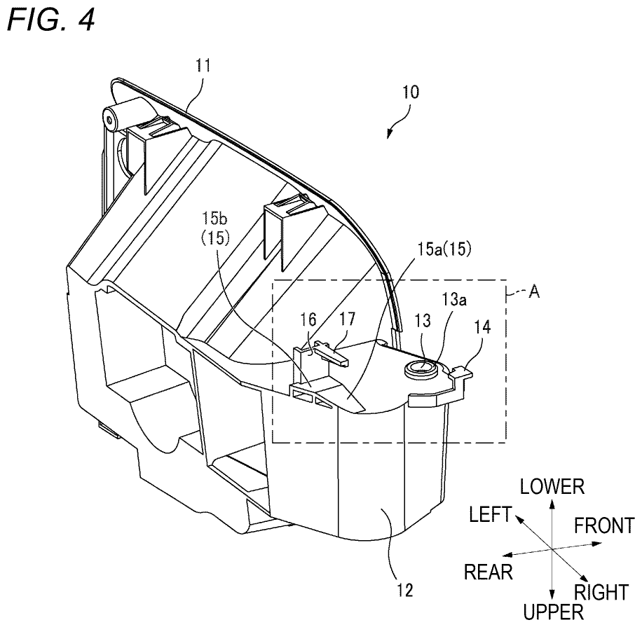

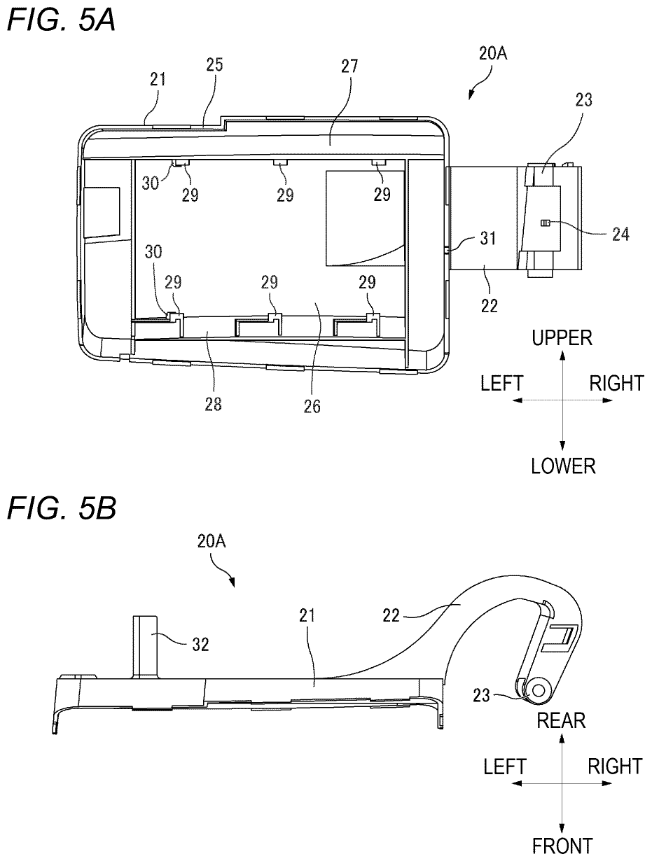

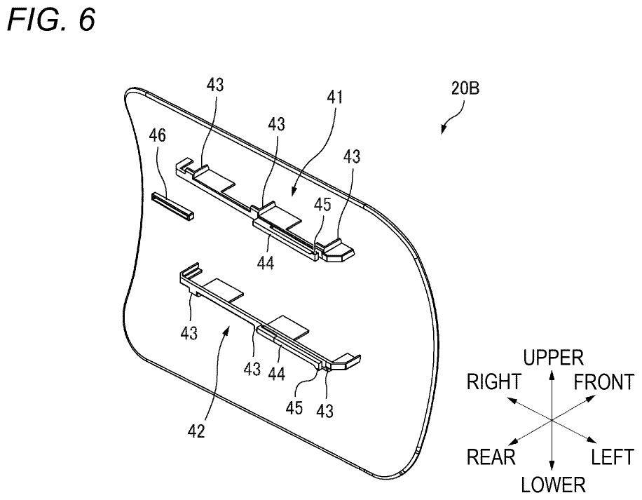

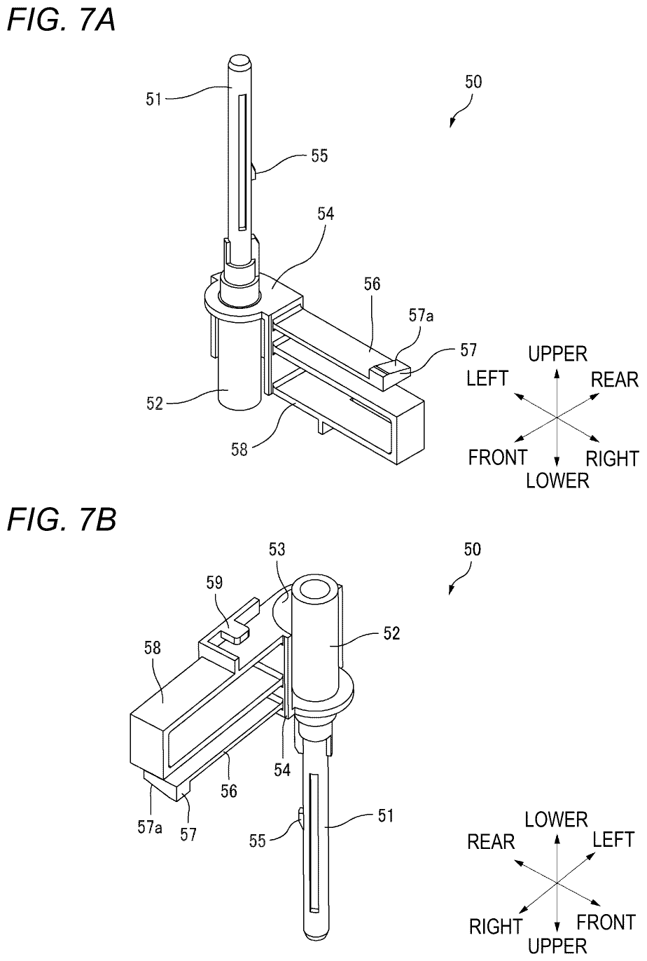

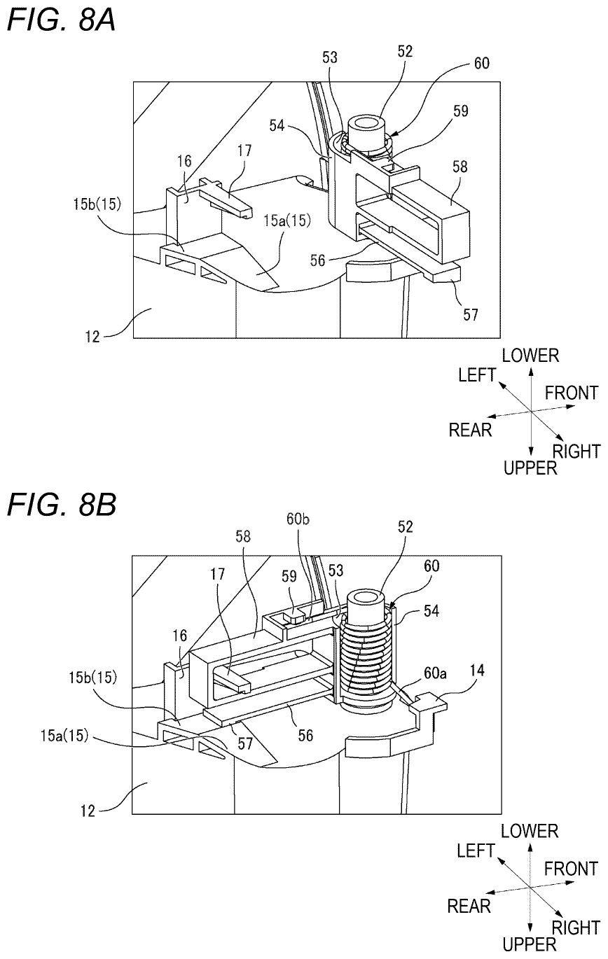

FIGS. 2A and 2B are perspective views of the lid device 1 according to the present embodiment, in which FIG. 2A illustrates a closed state of the lid 20, and FIG. 2B illustrates an open state of the lid 20. FIG. 3 is an exploded perspective view of a main part of the lid device 1 according to the present embodiment. FIG. 4 is a perspective view of a housing 10 in the lid device 1 according to the present embodiment as viewed from a lower side and a rear side. FIGS. 5A and 5B are views illustrating a support body 20A in the lid device 1 according to the present embodiment, in which FIG. 5A is a front view, and FIG. 5B is a top view. FIG. 6 is a perspective view of a lid body 20B in the lid device 1 according to the present embodiment as viewed from the rear side. FIGS. 7A and 7B are views illustrating a shaft member 50 in the lid device 1 according to the present embodiment, in which FIG. 7A is a perspective view viewed from an upper side, and FIG. 7B is a perspective view viewed from a lower side. FIGS. 8A and 8B are enlarged views of a portion A in FIG. 4, in which FIG. 8A illustrates an aspect when the lid 20 is in the closed state, and FIG. 8B illustrates an aspect when the lid 20 is in the open state (however, the lid 20 is not illustrated).

As illustrated in FIGS. 2A and 2B and FIG. 3, the lid device 1 includes the housing 10, the lid 20, the shaft member 50, and a biasing member 60. Hereinafter, the housing 10, the lid 20, the shaft member 50, and the biasing member 60 constituting the lid device 1 will be described in order.

First, the housing 10 will be described. The housing 10 is fitted and assembled to a recessed mounting portion (not illustrated) formed on the vehicle body such as the rear fender 2 of the vehicle. As illustrated in FIGS. 3 and 4, the housing 10 is formed in a substantially rectangular tubular shape. The housing 10 is provided with a flange portion 11 protruding radially outward on a side (front side) opposite to an assembly side (rear side) to the fuel filler port 3. An arm accommodation chamber 12 protruding outward is provided in a right side portion of the housing 10.

As illustrated in FIG. 4, a shaft hole 13 penetrating in the upper-lower direction is provided on a front side of a lower surface of the arm accommodation chamber 12. A pivoting shaft portion 51 of the shaft member 50 to be described later is inserted into the shaft hole 13. A peripheral edge portion 13a protruding downward from the lower surface of the arm accommodation chamber 12 is provided on a lower end edge of the shaft hole 13. A housing-side holding portion 14 that holds one end 60a of a biasing member 60 to be described later is provided in the vicinity of the peripheral edge portion 13a. Further, a sliding contact portion 15 with which an extending piece 56 of the shaft member 50 to be described later is brought into sliding contact is provided on a rear side of the lower surface of the arm accommodation chamber 12.

The sliding contact portion 15 has, on a closed position side in a pivoting direction of the lid 20, an inclined surface 15a formed in an inclined shape in which a sliding contact intermediate position with a protruding end surface 57a of the shaft member 50 to be described later is located on an extending piece 56 side (lower side) in the upper-lower direction with respect to a sliding contact start position. The sliding contact portion 15 has a horizontal surface 15b, which is a flat surface orthogonal to the upper-lower direction, on an open position side in the pivoting direction. The inclined surface 15a and the horizontal surface 15b are integrally formed.

A wall portion 16 is erected downward on an end portion of the horizontal surface 15b on an open position side in the pivoting direction. A rib 17 extending substantially parallel to the horizontal surface 15b in the upper-lower direction is provided on a lower end portion of the wall portion 16.

A fitting hole 19 penetrating in the front-rear direction is provided on a left side portion side of the housing 10. A fitting protrusion 32 of the lid 20 to be described later is inserted and fitted into the fitting hole 19. Accordingly, the closed state of the lid 20 is maintained.

Next, the lid 20 will be described. The lid 20 is pivotably supported by the shaft member 50 and is displaceable between the closed state (see FIG. 2A) and the open state (see FIG. 2B). As illustrated in FIG. 3, the lid 20 includes the support body 20A and the lid body 20B. In the support body 20A, a body portion 21 and an arm portion 22 are integrally formed. The body portion 21 is formed in a substantially plate shape, and the lid body 20B is attached to a front surface side of the body portion 21. The arm portion 22 is integrally connected to a right side portion of the body portion 21, and is curved so as to project to a rear side and formed in a substantially U shape when viewed in the upper-lower direction.

The support body 20A is assembled to the housing 10 by inserting the arm portion 22 from a front side of the housing 10 and accommodating the arm portion 22 in the arm accommodation chamber 12, and a tip end portion 23 of the arm portion 22 accommodated in the arm accommodation chamber 12 is pivotably supported by the pivoting shaft portion 51 of the shaft member 50 to be described later. Accordingly, the lid 20 can be opened and closed with respect to an opening portion formed in the flange portion 11 of the housing 10. The tip end portion 23 of the arm portion 22 is provided with a locked protrusion 24 to which a locking protrusion 55 of the shaft member 50 to be described later is locked (also see FIG. 5A).

As illustrated in FIGS. 3 and 5A, a peripheral wall portion 25 protruding forward is provided on a peripheral edge of the body portion 21. Further, a flat plate portion 26 is provided in a central portion of the body portion 21, and a label (not illustrated) on which, for example, the type of fuel to be supplied from the fuel filler port 3 is described can be attached to a rear surface of the flat plate portion 26.

As illustrated in FIGS. 5A and 5B, a pair of reinforcing ribs 27 and 28 are provided on the front surface side of the body portion 21. The reinforcing ribs 27 and 28 are formed along the left-right direction. Specifically, the reinforcing rib 27 is formed on an upper portion of the flat plate portion 26, and the reinforcing rib 28 is formed on a lower portion of the flat plate portion 26. Each upper surface of the reinforcing ribs 27 and 28 is an inclined surface inclined such that a free end side thereof faces downward. Strength of the lid 20 is further enhanced by providing the reinforcing ribs 27 and 28 in the body portion 21.

The reinforcing ribs 27 and 28 each have three L-shaped locking claws 29 on opposing sides thereof. That is, the locking claws 29 are formed on a lower surface of the reinforcing rib 27 and the upper surface of the reinforcing rib 28, and are disposed at intervals in the left-right direction.

Lock claws 30 are formed on the lower surface of the reinforcing rib 27 and the upper surface of the reinforcing rib 28, respectively. The lock claw 30 is formed at a formation position of the locking claw 29 at a position farthest from the arm portion 22 (leftmost side) among the locking claws 29.

An engagement recessed portion 31 is provided on a right side of the peripheral wall portion 25 of the body portion 21. An engagement protrusion 46 of the lid body 20B to be described later is engaged with the engagement recessed portion 31.

The fitting protrusion 32 protruding rearward is provided on a rear surface of the body portion 21 to correspond to the fitting hole 19 of the housing 10. The lid 20 is maintained in the closed state by inserting and fitting the fitting protrusion 32 into the fitting hole 19.

The lid body 20B is formed in an outer shape larger than the body portion 21 of the support body 20A, is formed in a curved shape such that a flat plate gently protrudes forward, and is attached to the body portion 21. Accordingly, the lid body 20B is attached to the body portion 21 in a state in which a peripheral edge portion thereof protrudes from an outer periphery of the body portion 21 over an entire periphery.

Two locking portions 41 and 42 are provided at an interval in the upper-lower direction on a rear surface of the lid body 20B, which is an attachment surface to the body portion 21, so as to correspond to the reinforcing ribs 27 and 28 of the body portion 21. The locking portions 41 and 42 are formed along the left-right direction. Each of the locking portions 41 and 42 includes three L-shaped locking claws 43 and a lock portion 44, the locking claws 43 of the locking portion 41 and the locking claws 43 of the locking portion 42 protruding to opposite sides. The locking claws 43 are formed at intervals in the left-right direction. A lock claw 45 is formed on the lock portion 44, and the lock claw 45 is disposed in the vicinity of one locking claw 43 on a left side portion side of the lid body 20B.

The engagement protrusion 46 extending in the left-right direction is formed on the right side portion side of a rear surface of the lid body 20B.

Here, in the attachment of the lid body 20B to the support body 20A, first, the lid body 20B is placed on the body portion 21 of the support body 20A in a state of being shifted to a left side, and the rear surface of the lid body 20B is brought into contact with a peripheral edge of the peripheral wall portion 25 of the body portion 21. In this state, the lock claw 45 of the lid body 20B is disposed in the vicinity of the lock claw 30 of the body portion 21, the locking claw 43 of the lid body 20B is disposed in the vicinity of the locking claw 29 of the body portion 21, and the engagement protrusion 46 of the lid body 20B is engaged with the engagement recessed portion 31 of the body portion 21.

Thereafter, the lid body 20B is slid rightward with respect to the body portion 21. At this time, since the engagement protrusion 46 of the lid body 20B is engaged with the engagement recessed portion 31 of the body portion 21, the lid body 20B is guided and smoothly slid with respect to the body portion 21. When the lid body 20B is slid rightward with respect to the body portion 21, the lock claw 45 of the lid body 20B is locked to the lock claw 30 of the body portion 21, and the locking claw 43 of the lid body 20B is locked to the locking claw 29 of the body portion 21. Accordingly, the attachment of the lid body 20B to the support body 20A (specifically, the body portion 21) is completed.

Next, the shaft member 50 will be described. The shaft member 50 is pivotally supported by the housing 10 and rotatably supports the lid 20. As illustrated in FIGS. 7A and 7B, the shaft member 50 integrally includes the substantially pin-shaped pivoting shaft portion 51 extending in the upper-lower direction, a mounted portion 52 formed in a substantially cylindrical shape having a larger diameter than the pivoting shaft portion 51 and on which the biasing member 60 is mounted, and a substantially semi-cylindrical peripheral wall portion 54 covering a half of an outer periphery of the mounted portion 52 such that a space 53 is defined between the peripheral wall portion 54 and the mounted portion 52.

The pivoting shaft portion 51 is inserted into the shaft hole 13 of the housing 10 and pivotably supports the lid 20. Further, the pivoting shaft portion 51 is provided with the locking protrusion 55 locked to the locked protrusion 24 of the lid 20. Since the locking protrusion 55 is locked to the locked protrusion 24 of the lid 20, the shaft member 50 supports the lid 20 and is prevented from falling off from the lid 20.

The peripheral wall portion 54 is integrally provided with a cantilever-shaped extending piece 56 extending rightward, and is elastically deformable in the axial direction that is a direction intersecting an extension direction (the left-right direction in the present example), that is, the upper-lower direction in the present example. In particular, the extending piece 56 is elastically deformed in the upper-lower direction (particularly downward in the present example) by being in sliding contact with the sliding contact portion 15 as described later. A protruding portion 57 protruding toward a sliding contact portion 15 side (upward) in the upper-lower direction is provided on an extending end (right end in this example) of the extending piece 56. The protruding end surface 57a (upper surface) of the protruding portion 57 is a sliding contact surface with the sliding contact portion 15 of the housing 10. The protruding end surface 57a is formed in an inclined shape corresponding to the inclined surface 15a so as to be in surface contact with the inclined surface 15a of the sliding contact portion 15.

Further, the peripheral wall portion 54 is provided with a reinforcing portion 58 that is formed in a substantially U shape and has both ends connected to the peripheral wall portion 54. When the lid 20 is in the open state, the reinforcing portion 58 is locked to or interferes with the rib 17 of the housing 10 when an elastic force of the extending piece 56 acts on the shaft member 50 toward a falling side (lower side in the present example) from the housing 10 in the axial direction. That is, the reinforcing portion 58, together with the rib 17 of the housing 10, prevents the shaft member 50 from falling off from the housing 10. A shaft member-side holding portion 59 that holds another end 60b of the biasing member 60 to be described later is provided on a lower surface of the reinforcing portion 58. The strength of the shaft member-side holding portion 59 is increased by the reinforcing portion 58.

Next, the biasing member 60 will be described. As illustrated in FIGS. 8A and 8B, the biasing member 60 is a so-called torsion spring, and has one end 60a held by the housing-side holding portion 14 of the housing 10 and the other end 60b held by the shaft member-side holding portion 59 of the shaft member 50. Accordingly, in the lid device 1, when the lock is released, the lid 20 is pivoted in a fully open direction by a biasing force of the biasing member 60.

The housing 10, the lid 20, the shaft member 50, and the biasing member 60 constituting the lid device 1 have been described above. Hereinafter, an operation of the extending piece 56 when the lid 20 is displaced from the closed position to the open position will be described.

In the lid device 1, when the lock of the housing 10 and the lid 20 is released, the lid 20 is pivoted toward the open position by the biasing force of the biasing member 60. At this time, the extending piece 56 also pivots in accordance with the pivoting of the pivoting shaft portion 51.

In the middle of the pivoting, the protruding end surface 57a of the protruding portion 57 in the extending piece 56 comes into contact with the inclined surface 15a of the sliding contact portion 15 in the housing 10, and the sliding contact of the protruding end surface 57a with the inclined surface 15a is started. As the pivoting of the lid 20 proceeds, the extending piece 56 is elastically deformed and climbs the inclined surface 15a so as to be brought into sliding contact with the inclined surface 15a. Accordingly, as the lid 20 approaches the open position, since friction generated between the extending piece 56 and the inclined surface 15a gradually increases, an opening speed of the lid 20 is attenuated in a stepwise manner. Thereafter, when the lid 20 reaches the vicinity of the open position, the protruding end surface 57a climbs over the inclined surface 15a, and when the lid 20 reaches the open position, the protruding end surface 57a is disposed on the horizontal surface 15b. The operation of the extending piece 56 when the lid 20 is displaced from the closed position to the open position has been described above.

As described above, according to the present embodiment, when the lid 20 is displaced from the closed position to the open position, the extending piece 56 provided on the shaft member 50 is brought into sliding contact with the sliding contact portion 15 provided on the housing 10. That is, when the lid 20 is opened, the extending piece 56 comes into sliding contact with the sliding contact portion 15, causing the friction to be generated between the extending piece 56 and the sliding contact portion 15, and thus momentum when the lid 20 is opened can be reduced.

As described above, the lid device 1 according to the present embodiment can reduce the momentum when the lid 20 is opened with a simple structure.

Further, according to the present embodiment, the inclined surface 15a of the sliding contact portion 15 is formed in the inclined shape in which the sliding contact intermediate position with the extending piece 56 is located on the extending piece 56 side (lower side) in the upper-lower direction with respect to the sliding contact start position, and the extending piece 56 is provided in the cantilever shape. Accordingly, from the start of the sliding contact of the extending piece 56 with the inclined surface 15a to the middle of the sliding contact, since the extending piece 56 is elastically deformed and climbs the inclined surface 15a so as to be brought into sliding contact with the inclined surface 15a, the friction generated between the extending piece 56 and the inclined surface 15a gradually increases as the lid 20 approaches the open position. That is, the momentum when the lid 20 is opened can be gradually reduced while reducing the load on the lid device 1 when the lid is opened. Further, by changing the inclination angle of the inclined surface 15a, the magnitude of the friction generated between the extending piece 56 and the inclined surface 15a changes, and thus the momentum when the lid 20 is opened can be adjusted.

Further, according to the present embodiment, the protruding portion 57 whose protruding end surface 57a is in sliding contact with the sliding contact portion 15 is provided on the extending end of the extending piece 56. Accordingly, since the magnitude of the friction generated between the protruding end surface 57a and the sliding contact portion 15 is changed by changing the area of the protruding end surface 57a, the momentum when the lid 20 is opened can be adjusted.

Further, according to the present embodiment, since the protruding end surface 57a is formed in the inclined shape so as to be in surface contact with the inclined surface 15a, the protruding end surface 57a and the inclined surface 15a are more engaged with each other at the time of the sliding contact, and thus it is possible to more appropriately reduce the momentum when the lid 20 is opened.

The present disclosure is not limited to the above-described embodiment, and modifications, improvements, and the like can be made as appropriate. In addition, materials, shapes, dimensions, numbers, arrangement positions, and the like of the constituent elements in the above-described embodiment are optional and are not limited as long as the present disclosure can be achieved.

According to the embodiment of the present disclosure, the lid device 1 that is attached to the fuel filler port 3 or the power supply port of the vehicle and opens and closes the fuel filler port 3 or the power supply port includes:
the housing 10 assembled to the fuel filler port 3 or the power supply port;
the shaft member 50 pivotally supported by the housing 10; and
the lid 20 pivotably supported by the shaft member 50 and displaceable between the closed position and the open position, in which
the shaft member 50 is provided with the extending piece 56 extending in a direction intersecting the axial direction, and
the housing 10 is provided with the sliding contact portion 15 with which the extending piece 56 comes into sliding contact when the lid 20 is displaced from the closed position to the open position.

According to this configuration, when the lid is displaced from the closed position to the open position, the extending piece provided on the shaft member is brought into sliding contact with the sliding contact portion provided on the housing. That is, when the lid is opened, the extending piece comes into sliding contact with the sliding contact portion, causing the friction to be generated between the extending piece and the sliding contact portion. With this configuration, it is possible to reduce the momentum when the lid is opened with the simple structure.

The extending piece 56 may be provided in the cantilever shape, and the sliding contact portion 15 may have the inclined surface 15a formed in the inclined shape in which the sliding contact intermediate position with the extending piece 56 is located on an extending piece side in the axial direction with respect to the sliding contact start position.

According to this configuration, the sliding contact portion has the inclined surface formed in the inclined shape in which the sliding contact intermediate position with the extending piece is located on the extending piece side in the axial direction with respect to the sliding contact start position, and the extending piece is provided in the cantilever shape. Accordingly, from the start of the sliding contact of the extending piece with the inclined surface to the middle of the sliding contact, since the extending piece is elastically deformed and climbs the inclined surface so as to be brought into sliding contact with the inclined surface, the friction generated between the extending piece and the inclined surface gradually increases as the lid approaches the open position. That is, the momentum when the lid is opened can be gradually reduced while reducing the load on the lid device when the lid is opened. Further, by changing the inclination angle of the inclined surface, the magnitude of the friction generated between the extending piece and the inclined surface changes, and thus the momentum when the lid is opened can be adjusted.

The protruding portion 57 that protrudes toward the sliding contact portion 15 side in the axial direction and whose protruding end surface 57a is in sliding contact with the sliding contact portion 15 is provided on the extending end of the extending piece 56.

According to this configuration, the protruding portion whose protruding end surface is in sliding contact with the sliding contact portion is provided on the extending end of the extending piece. Accordingly, since the magnitude of the friction generated between the protruding end surface and the sliding contact portion is changed by changing the area of the protruding end surface, the momentum when the lid is opened can be adjusted.

The protruding end surface 57a may be formed in the inclined shape so as to be in surface contact with the inclined surface 15a.

According to this configuration, since the protruding end surface is formed in the inclined shape so as to be in surface contact with the inclined surface, the protruding end surface and the inclined surface are more engaged with each other at the time of the sliding contact, and thus it is possible to more appropriately reduce the momentum when the lid is opened.

Although various embodiments have been described above, it is needless to say that the present disclosure is not limited to such embodiments. It is apparent to those skilled in the art that various variations or modifications can be conceived within the scope described in the claims, and it is understood that the variations or modifications naturally fall within the technical scope of the present disclosure. Further, the components described in the above embodiments may be freely combined without departing from the spirit of the disclosure.

What is claimed is:

1. A lid device that is attached to a fuel filler port or a power supply port of a vehicle and opens and closes the fuel filler port or the power supply port, the lid device comprising:
a housing assembled to the fuel filler port or the power supply port;
a shaft member pivotally supported by the housing; and
a lid pivotably supported by the shaft member and displaceable between a closed position and an open position, wherein
the shaft member is provided with an extending piece extending in a direction intersecting an axial direction, and
the housing is provided with a sliding contact portion with which the extending piece comes into sliding contact when the lid is displaced from the closed position to the open position.

2. The lid device according to claim 1, wherein
the extending piece is provided in a cantilever shape, and
the sliding contact portion has an inclined surface formed in an inclined shape in which a sliding contact intermediate position with the extending piece is located on an extending piece side in the axial direction with respect to a sliding contact start position.

3. The lid device according to claim 2, wherein
an extending end of the extending piece is provided with a protruding portion that protrudes toward a sliding contact portion side in the axial direction and whose protruding end surface is in sliding contact with the sliding contact portion.

4. The lid device according to claim 3, wherein
the protruding end surface is formed in an inclined shape so as to be in surface contact with the inclined surface.
